(19) United States
(12) Patent Application Publication
(10) Pub. No.: US 2005/0104264 A1
(43) Pub. Date: May 19, 2005

(54) Method for surface modification of oxide ceramics using glass and surface modifed oxide ceramics thereof

(76) Inventors: Seong-Jai Cho, Daejeon-si (KR); Min-Cheol Chu, Daejeon-si (KR); Hyun-Min Park, Daejeon-si (KR); Kyung-Jin Yoon, Seongnam-si (KR)

Correspondence Address: Richard C. Woodbridge, Esq.;Synnestvedt Lechner & Woodbridge, LLP, P.O. Box 592, Princeton, NJ, 08542-0592, US

(21) Appl. No.: 10/763,002

(22) Filed: Jan. 22, 2004

(30) Foreign Application Priority Data
Nov. 18, 2003 (KR) 2003-81462

(51) Int. Cl. C04B 33/34

(52) U.S. Cl. 264/602; 264/600

(57) ABSTRACT

A method for surface modification of oxide ceramics including the alumina ceramics used as heat resistant parts, wear resistant parts, the semiconductor fabricating parts, etc., and oxide ceramics produced by the method, in which the surface modification is carried out by permeating a glass into the surface of the oxide ceramics through heat treatment, so that the flexural strength, the heat resistance, and the wear resistance may be improved and the surface cracks may be cured. The surface modification method for oxide ceramics includes the step for carrying out heat treatment for the oxide ceramics and the glass at 1000-1700° C. for several seconds to several hours by using a heating element such as an electric heating furnace. According to the surface modification method for the oxide ceramics, the strength, the heat resistance, and the wear resistance of the oxide ceramics may be improved by simple procedure at a low cost.

### CROSS REFERENCE TO RELATED APPLICATIONS

This application claims the priority of Korean Application 2003-81462 filed on Nov. 18, 2003 and entitled METHOD FOR SURFACE MODIFICATION OF OXIDE CERAMICS USING GLASS AND SURFACE MODIFED OXIDE CERAMICS THEREOF by Seong-Jai CHO; Min-Cheol CHU; Hyun-Min PARK; and, Kyung-Jin YOON, the entire contents and substance of which are hereby incorporated in total by reference.

### BACKGROUND OF THE INVENTION

1. Field of the Invention

The present invention relates to a method for surface modification of oxide ceramics such as alumina used as heat-resistant parts, wear-resistant parts and parts for an apparatus for fabricating semiconductor goods, and oxide ceramics produced by the method.

More particularly, the present invention relates to a method for surface modification of oxide ceramics and oxide ceramics produced by the method, in which the surface modification is carried out by permeating a glass having low thermal expansion characteristics into the surface of oxide ceramics through heat treatment, so that the flexural strength, the heat resistance, and the wear resistance may be improved as well as the surface cracks may be cured.

2. Description of the Related Art

The oxide ceramics have high flexural strength by the strong ion binding between metal atoms and oxygen atoms, and exhibit high resistance for oxidation, high electric insulation, high resistance for oxygen and chemicals, and high chemical stability. Therefore, the oxide ceramics are utilized as parts of industrial machines such as bearings, cutting tools having the wear-resistance and corrosion resistance, as well as the environmental parts required for heat treatment in the fabrication of semiconductor goods. Accordingly, the oxide ceramics are widely utilized in various industrial fields as the heat resistant parts and tubes for atmospheric heat treatment.

As typical oxide ceramics, there are alumina ceramics which occupy almost half of the ceramic markets, and zirconia ceramics focused as the ceramics having superior mechanical properties.

However, the oxide ceramics have a disadvantage that the flexural strength of the material becomes decrease when defects exist on the surface by the natural brittleness, wherein a single principal crack may cause the radical destruction resulting in the deterioration of the reliability of products or parts. This disadvantage becomes the most severe obstacle in the application of the ceramics.

Further, the natural weakness of the ceramics are apt to cause the cracks on the surface of parts when machining the parts, thereby increasing the reject rate in the quality and accordingly increasing the fabricating cost of such parts.

In the case of alumina ceramics, which are the most generally used in the oxide ceramics, there is a further advantage that the strength is not sufficient. Therefore, the alumina ceramics are not proper for the highly advanced industrial application fields. Furthermore, the alumina ceramics have improper heat resistance temperature and insufficient wear resistance. Therefore, the alumina ceramics may be damaged when cooled at 240° C. at a high speed, and are not proper as mechanical seal materials used under the high stress conditions.

The zirconia ceramics overcome the above disadvantage of the alumina ceramics and have high strength and high resistance for thermal stress.

The zirconia ceramics have, however, still disadvantages such as the high specific gravity, the high thermal expansion and the low hardness, so that the zirconia ceramics are to be mainly used at a room temperature.

Further, the zirconia ceramics have a very high strength and a very high destruction property as ceramics. Therefore, many studies have been continued for improving the destruction property. However, a difference between the strength values of currently commercialized materials is higher than 100% maximally. Such a big deviation in the mechanical properties becomes the obstacle in the reliable design of the materials.

In order to overcome the disadvantages of the oxide ceramics, many studies have been continued for reinforcing the oxide ceramics by controlling the microstructures thereof for several tens of years. In particular, as for the zirconia ceramics in the oxide ceramics, the studies have been concentrated on the increase of the destruction property mainly. As for the alumina ceramics, the studies have been concentrated on the reducing of the cracks by reducing the size of particles and improving the strength to form compression stress on the surface by adding a second phase, carrying out the high speed heat treatment or substituting the surface layer with Cr₂O₃.

It is disclosed in the Korean Patent No. 329120 that the heat treatment is carried out at an atmosphere of a higher partial pressure of the oxygen (80N2-2002, O₂, etc.) after sintering powder molds including an additive such as Fe in the atmosphere of a lower partial pressure of oxygen (N2, 95N2-5H2, H2, etc.) in order to improve the durability and the wear resistance of the alumina ceramics.

### SUMMARY OF THE INVENTION

In order to achieve the above and other advantages and in accordance with the purpose of the present invention, as embodied and broadly described, the present invention has an object to provide a method for surface modification of oxide ceramics in which the mechanical properties such as the flexural strength, the resistance for thermal stress, and the wear resistance may be improved and the surface cracks generated in the procedure of machining may be simply cured at a low cost.

It is another object to provide surface modified oxide ceramics produced by the surface modification method.

According to the present invention, the surface properties of the oxide ceramics are improved by permeating a glass having a small thermal expansion coefficient into the surface of the oxide ceramics by heat treatment.

In order to achieve the above objects of the present invention, a method for surface modification of oxide ceramics, includes the steps of doping a glass component to a surface of oxide ceramics, and carrying out heat treatment for the oxide ceramics and the glass component at 1000-1700° C. for several seconds or several hours.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is view showing the microstructure of a surface of a work piece according to the present invention;

FIG. 2 is a view showing the internal microstructure of the work piece of FIG. 1;

FIG. 3 is view showing a Weibull plot on the data of the flexural strength of alumina ceramics with an unmodified surface as a comparison example with alumina ceramics of which surface was modified by permeating glass; and

FIG. 4 is a view showing the surface changes in the alumina ceramics of which surface was modified by permeating glass and the alumina ceramics having the unmodified surface as a comparison example, according to the temperature of cooling carried out at a high speed after the heat treatment.

### DETAILED DESCRIPTION OF THE PREFERRED EMBODIMENTS

The present invention will be explained in more detail with reference to preferred embodiments in junctions with the attached drawings.

The present invention is to provide a method for surface modification of oxide ceramics, which includes the steps of doping a glass component to a surface of oxide ceramics, and carrying out heat treatment for the oxide ceramics and the glass component at 1000-1700° C. for several seconds or several hours.

The heat treatment depends on the size of articles and the shaping heat treatment temperature. Therefore, it is difficult to set a proper time range but the heat treatment is preferably carried out for several seconds to 10 hours. As for a device for carrying out the heat treatment device, a general heating element such as an electric furnace is utilized.

The glass refers to a composite of various oxides based on SiO₂. In general, the glass has a thermal expansion coefficient relatively smaller than oxide ceramics in order to achieve the objects of the present invention. Especially, the glass preferably consists of MgO, Al₂O₃ and SiO₂ as principal components.

The theoretical base of the present invention is as follows.

In general, the oxide ceramics have a high melting point. Especially, alumina is molten at 2046° C., and zirconia is molten at 2700° C.

On the other hand, the glass is molten at a temperature of 1000° C. or higher even though it depends on the composition of the glass. Therefore, if heating the oxide ceramics at 1000° C. after laying down the oxide ceramics on the glass, the glass is molten to a liquid phase and permeated into the surface layer of the oxide ceramics.

Cracks of the oxide ceramics are filled with and cured by the permeated glass, so that the strength of the oxide ceramics is improved. Especially, if the glass having the thermal expansion coefficient smaller than the parent material, that is, the oxide ceramics, the compression stress is generated on the surface layer of the oxide ceramics while the oxide ceramics are cooled to the room temperature. Due to the compression stress, the oxide ceramics are improved in the strength, the resistance for the thermal stress and the wear resistance.

If any other metals than the glass are used in order to achieve the above objects, there is a disadvantage that the metals become oxides in the atmosphere by the heat treatment for melting the metals, wherein the prevention of the oxidation incurs high expenses. Therefore, glass is more appropriate for the object of the present invention.

Now, the present invention will be described in more detail with reference to examples hereinafter, but the present invention is not limited thereto.

### EXAMPLE 1

Surface Modification of Alumina Ceramics by Permeation of Low Thermal Expansive Glass

After Alumina ceramics were molded and sintered at 1650° C. for 2 hours, the sintered body is machined into a work piece in height of 3 mm, width of 4 mm, and length of 40 mm for testing the bending strength.

A glass piece consisting of MgO, Al₂O₃ and SiO₂ was laid on the alumina ceramics and subject to the heat treatment in the atmosphere at 1500° C. for 5-300 minutes, wherein the glass piece has a thermal expansion coefficient smaller than the alumina ceramics.

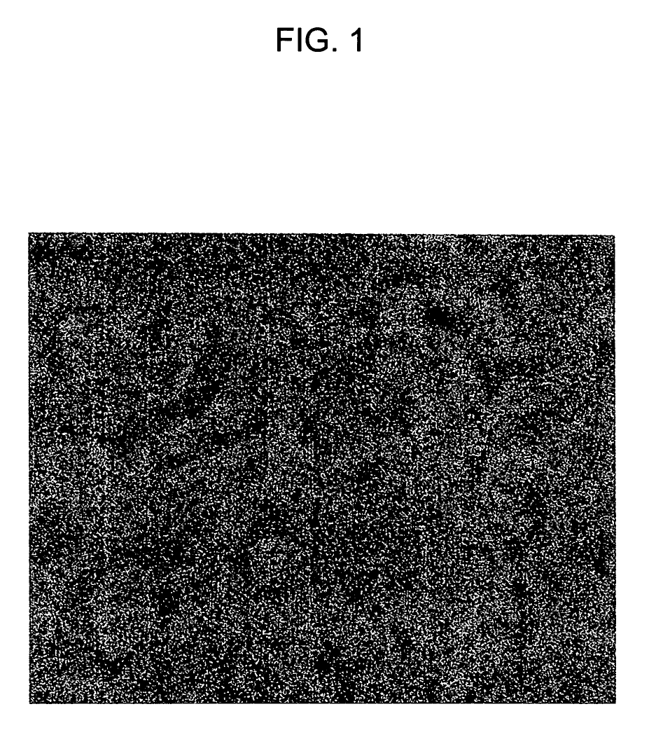

As a result of the heat treatment, as shown in FIG. 1, the glass was permeated to the surface of the work piece and filled between particles of the alumina ceramics, wherein bright parts represent the alumina ceramics and dark parts represent the permeated glass.

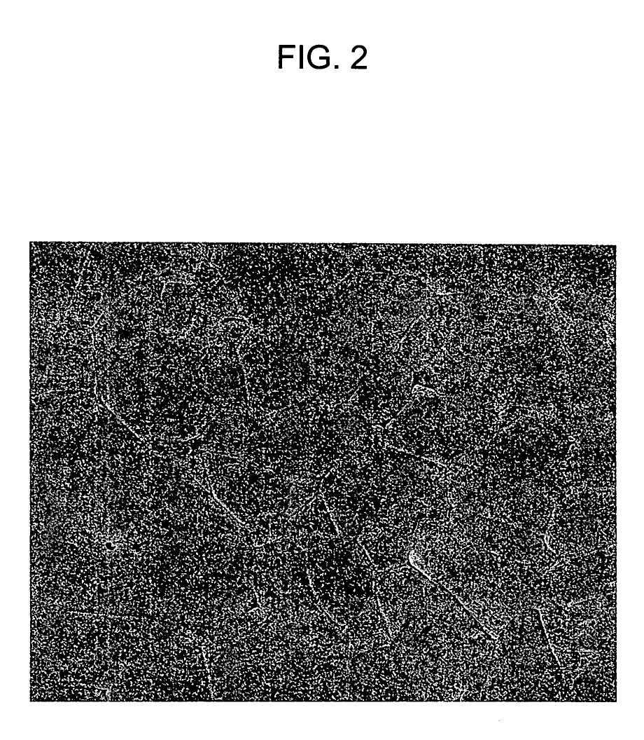

To the contrary, as shown in FIG. 2, the glass was not permeated to the inside of the work piece. The glass was permeated around the surface of the work piece and the permeation depth increased as time lapsed.

### EXAMPLE 2

Improvement of Flexural Strength According to the Surface Modification

A glass was permeated into a work piece by carrying out heat treatment at 1500° C. for 30 minutes, and a strength test was carried out after removing the glass from the surface of the work piece by grinding. As a comparison example, the original strength of the alumina ceramics, in which the glass was not permeated, was measured.

The strength measurement was carried out in accordance with the standards of ISO 14704, wherein 30 work pieces were measured respectively and averages and standard deviations were obtained.

Table 1 shows the original strength of the alumina ceramics and the strength data of the alumina ceramics after the permeation of the low thermal expansive glass.

TABLE 1

| | Strength (MPa) |
|---|---|
| Comparison Example: Original | 413 50 |
| Example: Strength after the Glass | 628 30 |

Table 1 exhibits that the strength of the alumina ceramics was increased by about 51% after the surface modification carried out by permeating the glass.

### EXAMPLE 3

Improvement in the Reliability of the Strength According to the Surface Modification

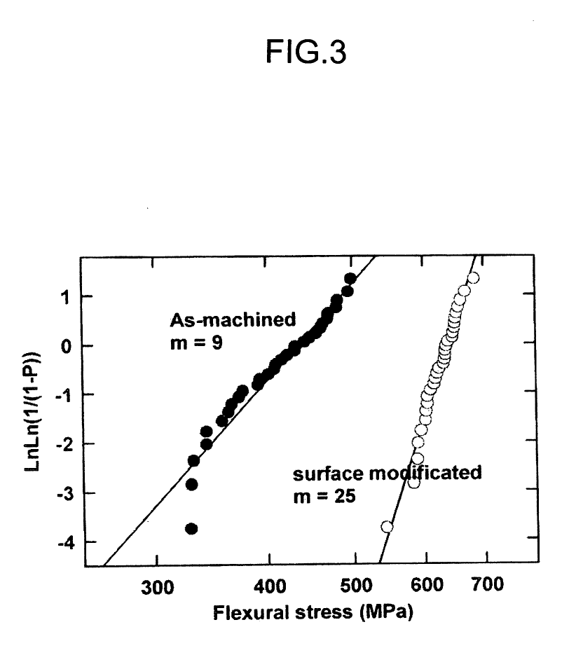

The strength data of the work piece of which surface modification carried out after permeating the glass according to the method of example 2 and the strength data of the work piece, of which surface modification was not carried out, were Weibull plotted as shown in FIG. 3.

In the case of the alumina ceramics of which surface modification was carried out by permeating the glass, Weibull modulus was about 25, and Weibull modulus of the alumina ceramics of which surface modification was not carried out was about 9, wherein the Weibull modulus of the surface modified alumina ceramics was noticeably larger that of the alumina ceramics having non modified surface.

This result exhibits that the reliability in the strength was noticeably improved by the surface modification.

### EXAMPLE 4

Improved of the Resistance for the Thermal Stress According to the Surface Modification

In order to observe whether cracks are generated by the thermal stress, the work piece of which surface modification was carried out by the glass permeation as described in example 2 and the work piece of which surface modification was not carried out, were heated at a predetermined temperature and cooled by water at a high speed.

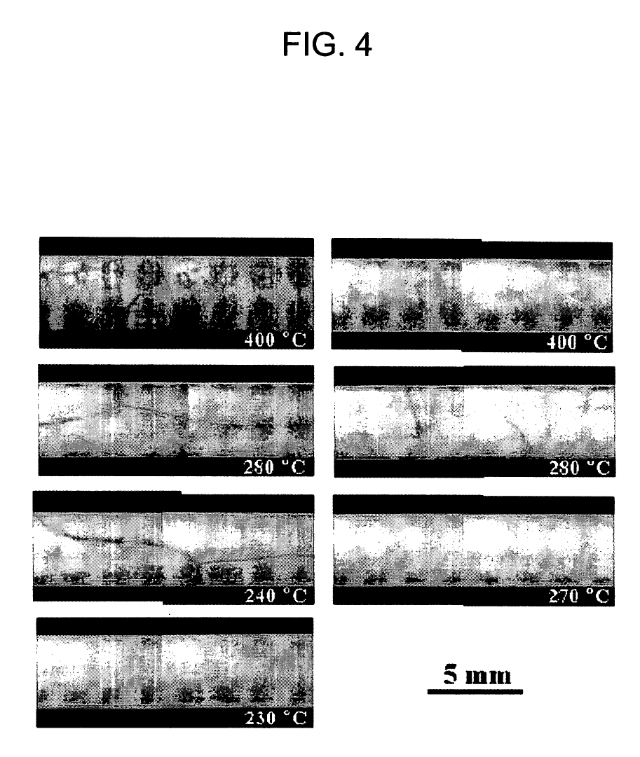

In order to simplify the observation of the crack generation, dye was permeated into the work pieces. As shown in FIG. 4, both work pieces have less cracks at a low heating temperature.

The cracks were generated in the work pieces having the non-modified surface without any exception if the work pieces were cooled at 240° C. or higher at a high speed (left side in FIG. 4). However, the cracks were not observed in the surface-modified work pieces in spite of the high speed cooling at 270-280° C. This exhibits that the resistance for the thermal stress was improved by the surface modification.

### EXAMPLE 5

Surface Modification of Zirconia by Permeating a Low Thermal Expansive Glass and the Improvement of Strength

Sintered zirconia ceramics were machined into a work piece with height of 3 mm, Width of 4 mm, and length of 40 mm for the bending strength test.

A glass piece consisting of MgO, Al₂O₃ and SiO₂ was laid on the work piece and the work piece was subject to the heat treatment in the atmosphere at 1450° C. for 5˜300 minutes.

The strength test was carried out after removing the glass permeated into the work piece by the heat treatment from the surface of the work piece by grinding. As a comparison example, the original strength of the zirconia ceramics, which was not permeated with the glass, was measured too.

The strength measurement was carried out in accordance with the standards of ISO 14704, wherein 30 work pieces were measured respectively and averages, standard deviations and Weibull coefficients were obtained.

Table 2 shows the original strength of the zirconia ceramics, the strength data of the zirconia ceramics after the permeation of the low thermal expansive glass, and the Weibull coefficients.

TABLE 2

| | Strength | Weibull |
|---|---|---|
| Comparison Example: Original | 760 169 | 5 |
| Example: Strength after the glass | 1038 93 | 12 |

Table 2 exhibits that the strength of the zirconia ceramics was increased by about 37% after the surface modification carried out by permeating the glass. Further, defect removing effect was recognized by the increase of the Weibull coefficient.

According to the method for surface modification of oxide ceramics of the present invention, the strength, the resistance for the thermal stress and the resistance for the wear may be improved by the simple procedure at a low cost. Since the strength becomes uniform, the reliability of parts and the materials becomes increased. Further, by curing the cracks, the reject rate during the machining or fabricating articles becomes reduced. Therefore, the present method and the surface modified oxide ceramics of the present invention may be widely utilized in various industrial fields in addition to the heat resistant parts, wear resistant parts and the fabrication of semiconductor goods.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

1. A method for surface modification of oxide ceramics, comprising the steps of:
doping a glass component to a surface of oxide ceramics; and
carrying out heat treatment for the oxide ceramics and the glass component at 1000-1700° C. for several seconds or several hours.

2. The method according to claim 1, wherein the glass has a thermal expansion coefficient smaller than the oxide ceramics.

3. The method according to claim 1, wherein the glass consists of MgO, Al2O3 and SiO2 as principal components.

4. The method according to claim 1, wherein the oxide ceramics is to be alumina ceramics, and subject to heat treatment at a temperature of 1500° C. for 5-300 minutes.

5. The method according to claim 2, wherein the oxide ceramics is to be alumina ceramics, and subject to heat treatment at a temperature of 1500° C. for 5-300 minutes.

6. The method according to claim 3, wherein the oxide ceramics is to be alumina ceramics, and subject to heat treatment at a temperature of 1500° C. for 5-300 minutes.

7. The method according to claim 1, wherein the oxide ceramics is to be zirconia ceramics, and subject to heat treatment at a temperature of 1450° C. for 5-300 minutes.

8. The method according to claim 2, wherein the oxide ceramics is to be zirconia ceramics, and subject to heat treatment at a temperature of 1450° C. for 5-300 minutes.

9. The method according to claim 3, wherein the oxide ceramics is to be zirconia ceramics, and subject to heat treatment at a temperature of 1450° C. for 5-300 minutes.

10. Oxide ceramics of which surface is modified according to a method as claimed in claim 1.

11. Oxide ceramics of which surface is modified according to a method as claimed in claim 2.

12. Oxide ceramics of which surface is modified according to a method as claimed in claim 3.

13. Oxide ceramics of which surface is modified according to a method as claimed in claim 4.

14. Oxide ceramics of which surface is modified according to a method as claimed in claim 5.
